(19) United States
(12) Patent Application Publication
(10) Pub. No.: US 2021/0229502 A1
(43) Pub. Date: Jul. 29, 2021

(54) Tire Tread Comprising Wavy Grooves and Sipes

(71) Applicant: COMPAGNIE GENERAL DES ETABLISSEMENTS MICHELIN, Clermont-Ferrand (FR)

(72) Inventors: Romain BERTHIER, Clermont-Ferrand Cedex 9 (FR); Fabien MARLIER, Clermont-Ferrand Cedex 9 (FR); Tony ZIVKOVIC, Clermont-Ferrand Cedex 9 (FR)

(21) Appl. No.: 17/059,394

(22) PCT Filed: May 28, 2019
(86) PCT No.: PCT/FR2019/051249

§ 371 Date: Nov. 27, 2020

(30) Foreign Application Priority Data
May 30, 2018 (FR) 1854617

(51) Int. Cl. B60C 11/12; B60C 11/03; B60C 11/13

(52) U.S. Cl. CPC B60C 11/1281; B60C 11/0323; B60C 2011/1361; B60C 2200/06; B60C 11/1259; B60C 11/1236; B60C 2011/0341

(57) ABSTRACT

Tread with longitudinally oriented grooves (31, 41, 42) at least one is wavy (31) opening onto tread surface (10), at least one rib (21) oriented in the longitudinal direction and delimited by (31) with external cavities (311) opening to tread surface and internal cavities (312) hidden within the thickness of the tread, cavities (311) opening onto the surface (10) when new with a contour (310) having farthest-spaced endpoints A and B separated by a distance Lm, the rib (21) of width Ln having transverse sipes (5), made at a mean pitch Pi, where the length Lm of contour (310) of cavity (311) is equal to or greater than an integer multiple N of the pitch Pi times an amount at most equal to 25% of this integer multiple N of the pitch Pi, when new, N+1 transverse sipes (5) of rib (21) open into cavity (311) bordering the rib.

### FIELD OF THE INVENTION

The invention relates to tire treads and more particularly to the tread patterns of these treads of which the performance in terms of clearing water in rainy weather is made more durable, these treads further exhibiting improved wearing performance; this invention also relates to the tires provided with such treads.

### PRIOR ART

In the known way, the conditions of running a heavy duty vehicle in rainy weather require rapid clearing of the water that may lie in the region in which the tire or, more particularly, its tread, makes contact with the road surface in order to ensure that the material of which the tread is made does make contact with this road surface The water which is not pushed ahead of and to the sides of the tire flows or is collected partially in the cuts or voids formed in the tread of the tire.

These cuts or voids form a fluid flow network which needs to be lasting, that is to say able to be effective throughout the service life of a tire between its new state and its removal on account of wear reaching a limit set by the manufacturer in accordance with the regulations in force.

For tires intended for the steering axles or load-bearing axles of a heavy-duty vehicle, it is common practice to form, in the tread of these tires, circumferential grooves (or longitudinal grooves), the depth of which is equal to the total thickness of the tread, this total thickness not taking into consideration the thickness that may be provided for allowing partial renewal of the grooves through an operation referred to as regrooving. Thus, it is possible to obtain a tread that has a water drainage performance which is always above a minimum performance referred to as the safe performance, this being true regardless of the level of wear of this tread.

For tires of the prior art, the total voids volume when new is, as a general rule, comprised between 10% and 25% of the total volume of the tread intended to be worn away during running (the total volume corresponding to the volume of material to which said total voids volume is added). These tires are found to have an available voids volume in the contact patch which is relatively high in the new state (available voids volume meaning that this volume is potentially able to be partially or completely filled with water present on the road surface). The volume of voids opening onto the tread surface in the contact patch is evaluated when the tire is subjected to its usual inflation and load conditions as defined in particular by the E.T.R.T.O. standard for Europe.

While cuts or, more generally, cavities are essential to draining away water in the contact patch in contact with the road surface, the resulting reduction in the volume of material on the tread may appreciably affect the wearing performance of this tread and consequently may reduce the service life of the tire as a result of an increase in the rate of wear of said tread.

Among the cuts which may be moulded into a tread, a distinction is made between grooves and sipes, the latter, unlike grooves, having a width appropriate for the opposing walls that delimit them to come at least partially into contact with one another when entering the contact patch. The grooves bring about a lowering of the compression and shear stiffnesses because these grooves delimit portions of material that are able to deform, compared with the portions delimited by sipes, the walls of which come to bear against one another when entering the contact patch. This decrease in stiffness, when grooves are present, causes an increase in deformation and is liable to bring about a reduction in the wearing performance of the tread. Greater wear is observed for a set distance covered and this corresponds to an increase in the rate of wear of the tread. Furthermore, an increase in rolling resistance and therefore in fuel consumption of vehicles equipped with such tires is observed as a result of an increase in the hysteresis losses associated with the cycles of deformation of the material of which the tread is made.

In order to limit the lowering in stiffness associated with the presence of the grooves a solution described in the patent publication WO 2011/039194 has been proposed. According to this solution, forming a tread for a tire intended for a heavy-duty vehicle is proposed, this tread being provided with a plurality of wavy grooves, these grooves undulating in the thickness of the tread and opening discontinuously, with regular or irregular spacing, onto the tread surface when new. Each wavy groove has a plurality of external cavities that are open onto the tread surface, these external cavities being separated from one another in the main direction of the wavy groove. The main direction of the wavy groove corresponds to the direction of the flow of water in the groove when running on ground covered in water. This wavy groove comprises, in addition to the external cavities, a plurality of internal cavities formed inside the tread, these internal cavities being placed radially and completely on the inside of the tread surface in the new state between the external cavities. The internal cavities may be designed to be situated at different depth levels in the thickness of the tread.

Moreover, the continuity of the flow of water, or more generally of fluid, in each wavy groove when new is ensured by the presence of linking cavities or intermediate cavities, each linking cavity connecting an external cavity to an internal cavity. Each linking cavity has two ends, one of these ends being connected to an internal cavity and the other end being connected to an external cavity.

Sipes are provided to connect the internal cavities and the linking cavities to the tread surface when new; these sipes making it easier to mould and demould the cavities formed under the tread surface of the tread.

By virtue of the presence of these linking cavities connecting the internal cavities and the external cavities, it is possible, when running on a road surface covered in water, to ensure circulation of the water from an external cavity to an internal cavity and thus to obtain suitable drainage and also good thermal ventilation of the tread. In addition, by virtue of this tread structure, the volume of all of the cavities is reduced in comparison with what it would be with grooves completely open to the tread surface when new, these having a depth corresponding to the bottoms of the internal cavities. This type of wavy groove thus makes it possible to limit the reduction in stiffness of the tread when new that is associated directly with the presence of the grooves.

This type of wavy groove may of course be combined with the presence of at least one groove open, over its entire length, to the tread surface of the tread right from new.

This type of wavy groove may be described as being a groove that when new opens discontinuously to the tread surface when new.

It has been found that the mere presence of wavy grooves alone does not make it possible to achieve the required level of grip under traction and under braking on certain heavy duty vehicles and that it was necessary to supplement these grooves with a plurality of sipes opening when new onto the tread surface in order to generate an additional length of edge corners beneficial to achieving a good level of traction and a good level of grip under so-called “slippery” conditions, notably on ground covered with water.

It is also been found that the combination of these sipes with wavy grooves notably comprising cavities that are open and cavities that are hidden when new could lead to uneven wear whenever said combination was not managed appropriately. What is meant here by uneven wear is wear that is not uniformly distributed over the entire tread surface but in which certain regions become more worn in comparison with other regions. This uneven wear may lead to tires being removed from a vehicle prematurely in order to be replaced with new tires, this considerably increasing the running cost per unit of distance travelled.

Definitions:

Each external cavity comprises opposing walls, these walls being connected together by a bottom that forms the bottom of the external cavity. The distance between the opposing walls defines a maximum width of the external cavity. The distance between the points of the bottom of the external cavity that are furthest towards the inside of the tread, and the tread surface when new, defines a depth of the external cavity. Each external cavity has a maximum length of opening onto the tread surface, this length being measured between the farthest-spaced points of the edge-corner contour when new of said external cavity.

The tread surface of a tread corresponds to all of the elementary surfaces of the tread that may come into contact with a road surface when a tire provided with such a tread is running.

In the present document, a radial direction means a direction which is perpendicular to the axis of rotation of the tire (this direction corresponds to the direction of the thickness of the tread).

A transverse or axial direction means a direction parallel to the axis of rotation of the tire.

A circumferential or longitudinal direction means a direction tangential to any circle centred on the axis of rotation. This direction is perpendicular both to the axial direction and to a radial direction.

The total thickness of a tread is measured in the new state, on the equatorial median plane of the tire provided with this tread, between the tread surface and the radially outermost part of the crown reinforcement.

A tread has a maximum thickness of material to be worn away during running, this maximum thickness of material to be worn away being, as a general rule, smaller than the total thickness of the tread.

The equatorial median plane is a plane perpendicular to the axis of rotation dividing the tire into two equal halves.

The usual running conditions of the tire or conditions of use are those which are defined by the E.T.R.T.O. standard for running in Europe; these conditions of use specify the reference inflation pressure corresponding to the load-bearing capacity of the tire as indicated by its load index and speed rating. These conditions of use may also be referred to as “nominal conditions” or “working conditions”.

### BRIEF DESCRIPTION OF THE INVENTION

The objective of the invention is to propose a tread comprising at least one longitudinally oriented wavy groove (that is to say a groove that is circumferential on the tire provided with said tread), this tread having a suitable level of grip, notably on ground covered with water, and not developing uneven wear while at the same time limiting running noise. For this tread, the risk of initiating cracks as the result of picking up a stone or as a result of excessive local deformation is also reduced.

To this end, the tread according to the invention comprises a tread surface, a thickness of material to be worn away during running, this thickness extending perpendicular to the tread surface. This tread is provided with a tread pattern formed by at least two longitudinally oriented grooves opening onto the tread surface of the tread, and of which at least one is a wavy groove. This tread comprises at least one rib oriented in the longitudinal direction of the tread and delimited by at least one of said wavy grooves. Each wavy groove comprises external cavities opening onto the tread surface and internal cavities hidden within the thickness of the tread.

The external cavities of each wavy groove open onto the tread surface when new with a contour of which the farthest-spaced endpoints A and B are separated by a longitudinal distance Lm, this distance Lm measuring the maximum length, in the longitudinal direction, of the contour of each external cavity. Each external cavity has a depth Ho.

The rib, of width Ln (equal to the shortest of the distances between the grooves delimiting said rib) comprises a plurality of transverse sipes (which is to say sipes oriented at 45 degrees or more to the longitudinal direction) made at a mean pitch Pi. The depth of the sipes is at least equal to the depth Ho of the external cavities of the wavy groove delimiting said rib.

The Tread is Characterized in that:
the longitudinal length Lm of the contour of the external cavity is equal to or greater than an integer multiple N of the pitch Pi times an amount at most equal to 25% of this integer multiple N of the pitch Pi,
when new, N+1 sipes of the one same rib open into each open cavity bordering said rib, one of these sipes opening near the end point A of the contour at a distance D1 from this point A, the second sipe opening near the other end point B of the contour at a distance D2 from this point B, the difference between the two distances D1 and D2 being at most equal to 5 mm.

As a preference, the total voids volume ratio when new is at most equal to 13% and more preferably still at most equal to 10%. This ratio is calculated by taking all the voids formed in the tread into consideration.

In a variant of the invention, the tread comprises several intermediate ribs and edge ribs, the latter axially flanking the intermediate ribs. Each intermediate rib is delimited by at least one wavy groove and is provided with a plurality of transverse sipes. Advantageously, on each intermediate rib:
the longitudinal length Lm of the contour of the opening of each external cavity onto the tread surface is equal to or greater than an integer multiple N of the pitch Pi of the sipes times an amount at most equal to 25% of this integer multiple N of the pitch Pi,
when new, N+1 sipes of the one same rib open into each open cavity bordering said rib, one of these sipes opening near the end point A of the contour at a distance D1 from this point A, the second sipe opening near the other end point B of the contour at a distance D2 from this point B, the difference between the two distances D1 and D2 being at most equal to 5 mm.

As a preference, the multiple N is identical for all the intermediate ribs. In this way, the possibility of non-uniformities in the distribution of mass in the circumferential direction, and the possibility of more pronounced wearing of certain parts of the tread during running are reduced.

As a preference, the distances D1 and D2 are equal, and this is the case for all the ribs.

Advantageously, the open cavities of the wavy grooves are offset so that they do not come into contact with the road surface simultaneously.

As a preference, the sipes on the intermediate ribs and open cavities of the wavy grooves are located on the tread in a way suitable for the sipes and these open cavities to come into contact with the road surface successively.

Furthermore, and in order to reduce the surface area of the opening of each external cavity when viewed from the tread surface when new, at least one thin blade of rubbery material is formed, each thin blade being attached to at least one of the walls delimiting each external cavity.

In the present description, a thin blade means a blade of rubbery material produced from the material of which the tread is made, this thin blade having a small but not necessarily constant thickness. A small thickness should be understood to mean a thickness appropriate for allowing the thin blade to bend towards the inside of the cavity during running on a road surface covered in water.

Advantageously, each thin blade has a thickness at most equal to 3 mm so as to allow bending under the action of a stream of liquid in the wavy groove. Even more preferentially, the thickness of each thin blade is at most equal to 2 mm.

Thanks to this latter arrangement and in combination with the proposed arrangement of the sipes opening near the ends of the contours of the external cavities, it is possible to reduce running noise appreciably.

By virtue of the flexibility of these thin blades, the circulation of the water is not impeded too much during running on a road covered in water.

The invention also relates to a tire for a heavy duty vehicle provided with a tread as described hereinabove.

Further features and advantages of the invention will become apparent from the following description provided with reference to the appended drawings which show, by way of non-limiting examples, embodiments of the subject matter of the invention.

### BRIEF DESCRIPTION OF THE FIGURES

FIG. 1 depicts a view of the surface of a tread of a heavy duty vehicle of a first variant of the invention, for which N is equal to 1;

FIG. 2 shows a view in section on a plane of which the line in FIG. 1 is identified as II-II;

FIG. 3 shows a view in section on a plane of which the line in FIG. 1 is identified as III-III;

FIG. 4 shows a view of the surface of another variant of a tread for a tire of a heavy duty vehicle according to the invention and for which N is equal to 2.

### DESCRIPTION OF THE FIGURES

In order to make the figures easier to understand, identical reference signs may be used to describe different variants of the invention where these reference signs refer to elements of the same kind, whether this be in terms of structure or in terms of function.

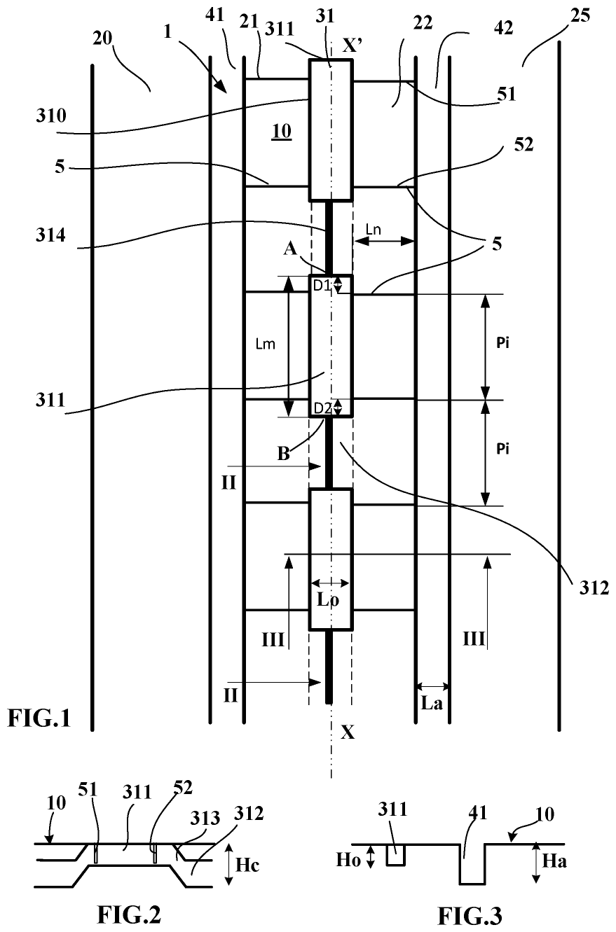

With reference to FIG. 1, the first variant of the invention describes a tread 1 having a tread surface 10 intended to be in contact with a road surface when a tire provided with said tread is running. This tread 1 has a thickness of material to be worn away during running, in which thickness cuts, grooves or sipes are formed.

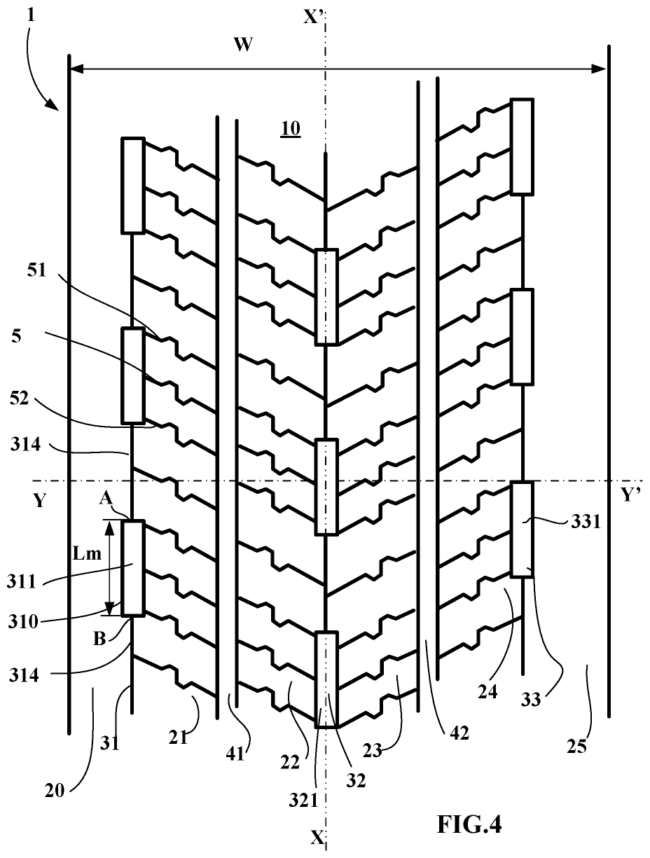

FIG. 1 shows the view of the tread surface 10 of this tread, this tread comprising three circumferentially oriented grooves 31, 41, 42 (running in the circumferential direction indicated by the line XX′). These three grooves delimit two intermediate circumferential ribs 21, 22 and two edge ribs 20, 25 axially on the outside. Two of these grooves 41, 42 are cuts that are open over their entire length onto the tread surface of the tread when new. These two grooves 41, 42 have the same mean width La and a depth Ha (visible in FIG. 3). These two grooves flank a third wavy groove 31, undulating into the thickness of the tread.

This wavy groove 31 comprises external cavities 311 opening onto the tread surface 10 and internal cavities 312 hidden within the thickness of the tread. The internal cavities 312 are connected to the open external cavities 311 by linking cavities 313 (visible in FIG. 2) ensuring continuity of a flow of fluid in the groove when new and until a predetermined level of partial wear is reached.

The external cavities 311 of each wavy groove open onto the tread surface 10 when new and are bounded by a contour 310 of rectangular shape elongate in the circumferential direction and of which the the farthest-spaced endpoints A and B are separated by a longitudinal distance Lm, this distance Lm measuring the maximum length, in the longitudinal direction, of the rectangular contour of each external cavity 311. Each external cavity 311 has a mean width Lo, equal in the variant described to the width La of the other grooves, and a depth Ho, this depth corresponding to the level of tread wear for which the external cavities 311 disappear.

To facilitate the moulding and demoulding of the tread, the formation of circumferential sipes 314, opening onto the tread surface 10 and into the hidden cavities 312 and into the linking cavities 313, is planned.

Each of the two intermediate ribs 21, 22 of the tread is delimited both by a groove 41 or 42, that is open over its entire length, and by the wavy groove 31.

The intermediate ribs 21, 22 have the same width Ln that measures the shortest width between the grooves delimiting them. The maximum width of these intermediate ribs is equal to the sum of this shortest width and half the width of the external cavities 311.

Moreover, each of the intermediate ribs 21, 22 is provided with a plurality of transverse sipes 5 which in this instance make an angle of 90 degrees with the circumferential direction XX′. These sipes 5 are arranged on each intermediate trip 21, 22 with the same mean pitch Pi. The depth of these sipes is equal to the maximum depth Hc of the hidden cavities of the wavy groove. This maximum depth Hc of the hidden cavities 312 being equal to the depth Ha of the open grooves 41, 42. In this variant, two sipes 5 open into each open cavity.

Furthermore, the Tread is Such that:
the longitudinal length Lm of the contour of each external cavity of the wavy groove 31 is in this example slightly greater than the pitch Pi of the transverse sipes 5, by the order of 10%;
when new, two sipes 51, 52 of the one same intermediate rib 21, 22 open into each open cavity 311 bordering said rib, a sipe 51 opening near one end A of the rectangular contour 310 corresponding to a corner of said rectangle, namely at a non-zero distance D1 from this point A, the other sipe 52 opening near the other end point B of the rectangular contour, namely at a non-zero distance D2 from this point B. The distances D1 and D2 are equal in the example described and their sum is equal to 10% of the pitch Pi.

FIG. 2 shows a view in section on a plane of which the line in FIG. 1 is identified as II-II.

FIG. 3 shows a view in section on a plane of which the line in FIG. 1 is identified as III-III.

In this first variant, the sipes on each intermediate rib have the same layout with respect to the external cavities of the wavy grooves.

By virtue of this arrangement of the transverse sipes 51, 52 and of the external cavities 311 of the wavy groove 31, it is possible to create a tread having a satisfactory level of grip, notably when running on ground covered with water, and that does not develop uneven wear while at the same time limiting running noise. Furthermore, this tread reduces the risk of the initiation of cracks associated with picking up a stone.

FIG. 4 shows the tread surface of a tread 1 of a heavy duty tire of size 315/70 R 22.5.

This tread 1 has a width W equal to 265 mm and a thickness of material to be worn away equal to 11 mm; it is provided with a tread pattern formed of five circumferentially oriented grooves and obliquely oriented sipes.

This tread comprises three wavy grooves 31, 32, 33 in its thickness and, interposed between these wavy grooves, two open grooves 41, 42, open, over their entire length, onto the tread surface 10 when new.

The open grooves 41, 42 that are open over their entire length have a depth of 12 mm and a width equal to 8 mm.

The wavy grooves 31, 32, 33 comprise external cavities 311, 321, 331 which are open onto the tread surface when new, and internal cavities hidden within the tread, these external and internal cavities being connected to one another by linking cavities. The mean width of these cavities is equal to 8 mm. Each external cavity 311, 321, 331 has a depth equal to 6 mm. Furthermore, a sipe 314, 324, 334 of width 0.6 mm connects each hidden cavity to the linking cavities formed on each side of the hidden cavity. The innermost point of the wavy grooves are at a depth equal to 12 mm.

The dimensions given for the wavy groove 31 are also found on the other wavy grooves 32, 33. The external cavities 311 have a contour 310 on the tread surface 10 when new that is of elongate rectangular shape with a maximum length Lm that is equal in this variant to 77 mm (this length measures the distance between the points A and B situated at the end of this contour corresponding to the points of connection to the circumferential sipes 314). These external cavities 311 are arranged in the circumferential direction at a pitch equal to 154 mm.

The tread pattern of the tread thus delimits four intermediate ribs 21, 22, 23, 24 and two edge ribs 20, 25, these latter axially delimiting the width W of the tread. Each intermediate rib is delimited by a wavy groove and by a groove that is open over its entire length.

The grooves are arranged in such a way that the intermediate ribs all have the same minimum width Ln equal to 34 mm.

This tread has a volume voids ratio when new of 12.5%

Furthermore, each intermediate rib comprises a plurality of sipes 5 of oblique overall orientation which are mutually parallel on the one same rib and arranged at a mean pitch Pi (corresponding to the mean distance between two sipes measured in the circumferential direction); in this instance this pitch Pi is equal to 33 mm.

The overall orientation of a sipe 5 is obtained as being the angle made by a segment of straight line passing through the endpoints of the sipe with the transverse direction—indicated by the axis YY′ in the plane of FIG. 4. These sipes 5 are made on all the intermediate ribs with an overall orientation that makes a mean angle—in terms of absolute value—equal to 15 degrees to the transverse direction. Furthermore, these sipes 5 are arranged on the intermediate ribs in order to give the tread pattern of the tread 1 a directional nature, the sipes 5 on one half of the tread having the one same orientation, whereas on the other half the angle of orientation is of opposite value.

In order to obtain a good level of performance in terms of grip, notably on ground covered with water, without developing uneven wear and while at the same time limiting running noise, three sipes 5 open onto each external cavity 311 of the wavy grooves. Of these three sipes 5, the two sipes 51, 52 closest to the ends A and B of the contour of each external cavity 311 are situated at respective distances D1 equal to 7.1 mm, and D2 equal to 3.9 mm, from said ends A and B.

By positioning these sipes 51, 52 as close as possible to the ends A and B of the contour 310 of each external cavity 311, and by limiting the difference between these distances, it is, surprisingly, possible to solve the mentioned problems and also limit the risk of initiating cracks as a result of picking up a stone.

The invention described with the support of two variants is of course not restricted to these variants alone, and various modifications can be made thereto while still remaining within the scope defined by the claims.

1. A tire tread comprising a tread surface, a thickness of material to be worn away during running, this tread being provided with a tread pattern formed by at least two longitudinally oriented grooves opening onto the tread surface of the tread, and of which at least one is a wavy groove, this tread comprising at least one rib oriented in the longitudinal direction of the tread and delimited by said at least one wavy groove, each wavy groove comprising external cavities opening onto the tread surface and internal cavities hidden within the thickness of the tread, the external cavities of each wavy groove opening onto the tread surface when new with a contour of which the longitudinally farthest-spaced endpoints (A, B) are separated by a longitudinal distance Lm, this distance Lm measuring the maximum longitudinal length of the contour of each external cavity, each external cavity having a depth Ho, the rib of width Ln comprising a plurality of transverse sipes, which is to say sipes oriented at 45 degrees or more to the longitudinal direction, made at a mean pitch Pi, the depth of these transverse sipes being at least equal to the depth Ho of the external cavities of the wavy groove delimiting said rib, wherein:
the longitudinal length Lm of the contour of the external cavity is equal to or greater than an integer multiple N of the pitch Pi times an amount at most equal to 25% of this integer multiple N of the pitch Pi,
when new, N+1 transverse sipes of the one same rib open into each open cavity bordering said rib, one of these transverse sipes opening near the end point A of the contour (310) at a distance D1 from this point A, another transverse sipe opening near the other end point B of the contour at a distance D2 from this point B, the difference between the two distances D1 and D2 being at most equal to 5 mm.

2. The tread according to claim 1, wherein the total voids volume ratio when new is at most equal to 13%.

3. The tread according to claim 1, wherein the tread comprises several intermediate ribs and edge ribs, the latter axially flanking the intermediate ribs, each intermediate rib being delimited by at least one wavy groove and being provided with a plurality of transverse sipes, and on each intermediate rib:
the longitudinal length Lm of the contour of the opening of each external cavity onto the tread surface is equal to or greater than an integer multiple N of the pitch Pi of the transverse sipes times an amount at most equal to 25% of this integer multiple N of the pitch Pi,
when new, N+1 transverse sipes of the one same rib open into each open cavity bordering said rib, one of these sipes opening near the end point A of the contour at a distance D1 from this point A, another sipe opening near the other end point B of the contour at a distance D2 from this point B, the difference between the two distances D1 and D2 being at most equal to 5 mm.

4. The tread according to claim 1, wherein the multiple N is identical for all the intermediate ribs.

5. The tread according to claim 1, wherein the distance D1 is equal to the distance D2 for all the ribs.

6. The tread according to claim 1, wherein the open cavities of the wavy grooves are offset from one another so that these external cavities do not come into contact with the road surface at the same time.

7. The tread according to claim 1, wherein the transverse sipes are offset on the intermediate ribs and the open cavities on the wavy grooves in a way suitable for the transverse sipes and these open cavities to come into the contact patch successively.

8. The tread according to claim 1, wherein at least one thin blade of rubbery material is formed at the ends of the contour of the external cavities, each thin blade being attached to at least one of the walls delimiting each external cavity.

9. The tread for a heavy duty vehicle provided with a tread according to claim 1.
